(19) United States
(12) Patent Application Publication
(10) Pub. No.: US 2008/0218699 A1
(43) Pub. Date: Sep. 11, 2008

(54) DISPLAY DEVICE HAVING PLURALITY OF LIGHT SOURCES AND USING DIFFRACTIVE LIGHT MODULATOR, CAPABLE OF REDUCING SPECKLES

(75) Inventors: Anatoliy Lapchuk, Suwon (KR); Haeng Seok Yang, Bucheon-si (KR); Victor Yurlov, Suwon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/039,653

(22) Filed: Feb. 28, 2008

(30) Foreign Application Priority Data
Mar. 8, 2007 (KR) 10-2007-0023103

(51) Int. Cl. G03B 21/20; G03B 21/28

(52) U.S. Cl. 353/31

(57) ABSTRACT

Disclosed herein is a display device using a diffractive light modulator, which is provided with a plurality of light sources that emit different wavelengths, thus being capable of reducing speckles. The display device using a diffractive light modulator includes a light source unit, an illumination unit, a diffractive light modulator, and a projection unit.

### CROSS REFERENCE TO RELATED APPLICATION

This application claims the benefit of Korean Patent Application No. 10-2007-0023103, filed on Mar. 8, 2007, entitled “Display Apparatus of the Diffractive Optical Modulator having Multiple Light Source for reducing the Speckle,” which is hereby incorporated by reference in its entirety into this application.

### BACKGROUND OF THE INVENTION

1. Field of the Invention

The present invention relates generally to a display device using a diffractive light modulator and, more particularly, to a display device using a diffractive light modulator, which is provided with a plurality of light sources that emit different wavelengths, thus being capable of reducing speckles.

2. Description of the Related Art

Active research into various Flat Panel Displays (FPDs) has been conducted in order to develop next generation display devices. Of them, generalized FPDs include Liquid Crystal Displays (LCDs) using the electro-optic characteristics of liquid crystal, and Plasma Display Panels (PDPs) using gas discharge.

LCDs are disadvantageous in that the viewing angle thereof is narrow, the response speed thereof is slow, and the manufacturing process thereof is complicated because Thin Film Transistors (TFTs) and electrodes must be formed using a semiconductor manufacturing process.

In contrast, PDPs are advantageous in that the manufacturing process thereof is simple, and is thus suitable for the implementation of large-sized screens, but are disadvantageous in that the power consumption thereof is high, the discharge and light emission efficiency thereof are low, and the price thereof is high.

New types of display devices, which can solve the disadvantages of the above-described FPDs, have been developed. Recently, there has been proposed a display device that can display images through micro Spatial Light Modulators (SLMs), which are formed for respective pixels using Micro Electromechanical Systems (hereinafter referred to as “MEMSs”), which are based on an ultra-micro machining technology.

SLMs are converters that are configured to modulate incident light into a spatial pattern corresponding to an electrical or optical input. The incident light may be modulated in phase, intensity, polarization or direction. Optical modulation can be achieved using several materials that have several electro-optic or magneto-optic effects or material that modulates light through surface deformation.

Since such a display system using a diffractive light modulator uses a coherent light beam, speckles are generated due to a coherence phenomenon. Speckles are a random interference pattern that is formed by light that is scattered due to the roughness of the surface of an object when coherent light is reflected on the surface of the object, enters the eyes of a human, and is focused on the retinas of the eyes. When speckles appear in an image, the eyes are fatigued.

Many techniques for reducing or eliminating speckles in an optical system provided with a display system using a diffractive light modulator have recently become known. An example of these techniques is a “Method and Apparatus for reducing Laser Speckle,” which is disclosed in International Application No. PCT/US2001/31418, filed on Oct. 4, 2001, and is illustrated in FIGS. 5 to 7.

As illustrated in FIGS. 5 and 6, the prior art display system 40 includes display optics 42 and display electronics 44.

The display optics 42 include a laser 46, illumination optics 48, a Grating Light Valve (GLV) 50, Schlieren optics 52, a wavefront modulator 54, projection and scanning optics 56, and a display screen 58. The display electronics 44 are electrically coupled to the laser source 46, the GLV 50, and the projection and scanning optics 56.

The laser 46 emits laser illumination.

The illumination optics 48 include a divergent lens 74, a collimation lens 76, and a cylindrical lens 78. The illumination optics 48 focus the laser illumination onto the GLV 50.

The GLV 50 modulates the laser illumination as the linear array of pixels along the focus line, forming the reflected light R or the diffracted light, including the plus one and minus one diffraction orders, D₊₁ and D₋₁, for each pixel.

The Schlieren optics 52 include a Schlieren stop 80 located between first and second relay lenses 82 and 84. The Schlieren stop 80 stops the reflected light R and allows the plus one and minus one diffraction orders, D₊₁ and D₋₁, to pass the Schlieren stop 80.

The wavefront modulator 54 preferably includes a transmissive diffraction grating with a grating profile at least partially orthogonal to the line image, and varies the phase across the line image width.

The projection and scanning optics 56 include a projection lens 86 and the scanning mirror 88. The projection and scanning optics 56 project a line image onto the display screen 58, and scan the line image across the display screen 58 to form a two dimensional image on the display screen 58.

The display optics 42 having the above-described construction reduce speckles in such a way that the wavefront modulator 54 generates a multi-speckle pattern by varying the phase of laser illumination. In this case, a transmissive diffraction grating having a grating profile 110, which is formed on one surface of the transmissive diffraction grating and is inclined at an angle of about 45°, as shown in FIG. 7, is required as the wavefront modulator 54.

However, the transmissive diffraction grating required for the wavefront modulator 54 having the above-described construction has problems in that it is difficult to fabricate the transmissive diffraction grating and the time required for the fabrication thereof is long because the work of forming a grating on one surface thereof is difficult and complex.

Furthermore, the prior art display system has problems in that image quality and optical efficiency are degraded because the laser is diffracted through a diffraction grating.

### SUMMARY OF THE INVENTION

Accordingly, the present invention has been made keeping in mind the above problems occurring in the prior art, and an object of the present invention is to provide a display device using a diffractive light modulator, which is capable of reducing speckles using light sources that emit beams of light having respective wavelengths, so that it can be easily fabricated and does not degrade image quality or optical efficiency.

In order to accomplish the above object, the present invention provides a display device using a diffractive light modulator, which includes a light source unit for generating light, including a plurality of wavelengths corresponding to each relevant color, using a plurality of light sources that emit light in a wavelength band corresponding to the color, and emitting the light; an illumination unit for focusing the emitted light; a diffractive light modulator for generating diffracted light by modulating the focused light; and a projection unit for magnifying the modulated light and projecting the magnified modulated light onto a screen.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a display device having a plurality of light sources and using a diffractive light modulator, which is capable of reducing speckles, according to an embodiment of the present invention;

FIG. 2 is a diagram showing incident angles at which beams of light, emitted from the plurality of light sources of FIG. 1, enter the diffractive light modulator;

FIG. 3 is a diagram showing the relationship between the distances between the light sources of the light source array of FIG. 1 and incident angles;

FIG. 4 is a diagram showing an example of the diffractive light modulator of FIG. 1;

FIG. 5 is a schematic block diagram of a prior art laser projection display system;

FIG. 6 is a schematic diagram of the projection display system of FIG. 5; and

FIG. 7 is a schematic sectional diagram showing a transmissive diffraction grating that is installed in the wavefront modulators of FIGS. 5 and 6.

### DESCRIPTION OF THE PREFERRED EMBODIMENTS

Reference now should be made to the drawings, in which the same reference numerals are used throughout the different drawings to designate the same or similar components.

With reference to the accompanying drawing, display devices using diffractive light modulators, each of which is provided with a plurality of light sources in order to reduce speckles according to embodiments of the present invention, will be described in detail below.

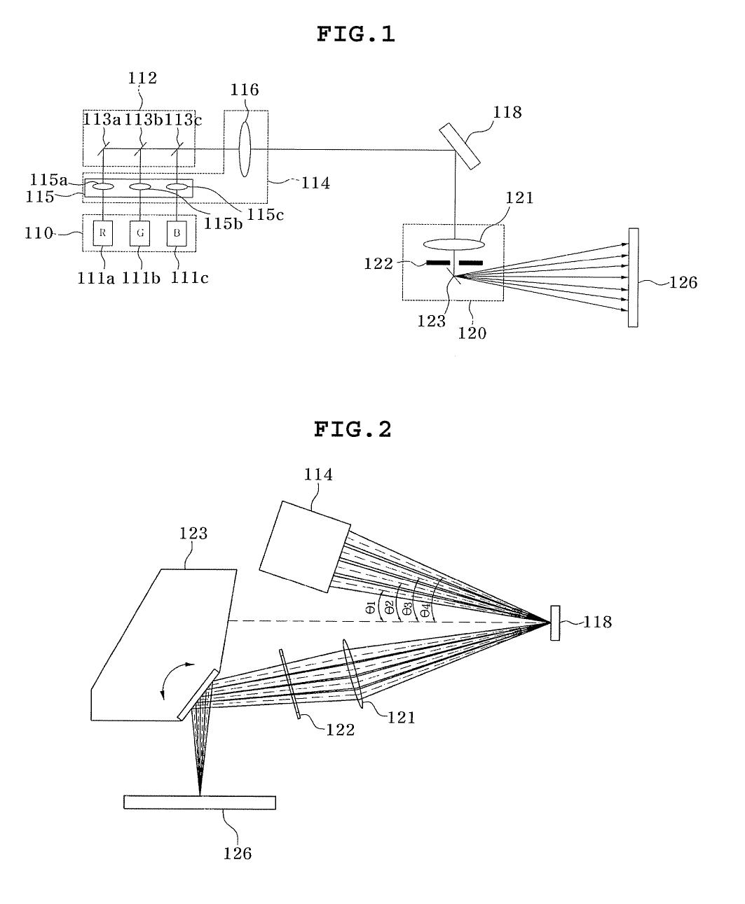

FIG. 1 is a view showing the construction of a display device using a diffractive light modulator, which is provided with a plurality of light sources in order to reduce speckles according to an embodiment of the present invention.

Referring to this drawing, the display device using a diffractive light modulator, which is provided with a plurality of light sources in order to reduce speckles according to the embodiment of the present invention, includes a light source unit 110, a light condensing unit 112, an illumination unit 114, a diffractive light modulator 118, and a projection unit 120.

Here, the light source unit 110 generates and emits a plurality of beams of light, for example, red light, green light, and blue light, in order to realize color images.

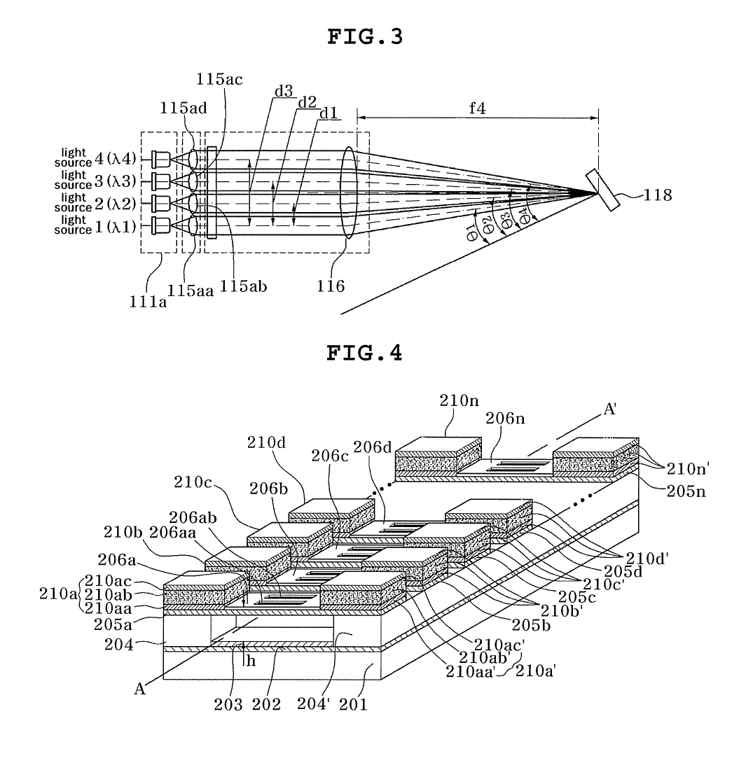

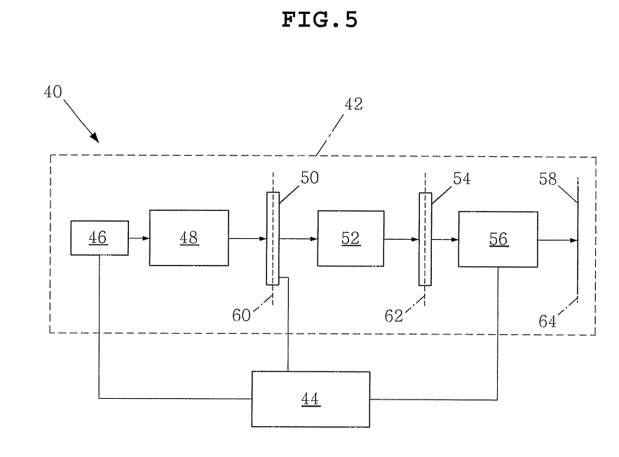

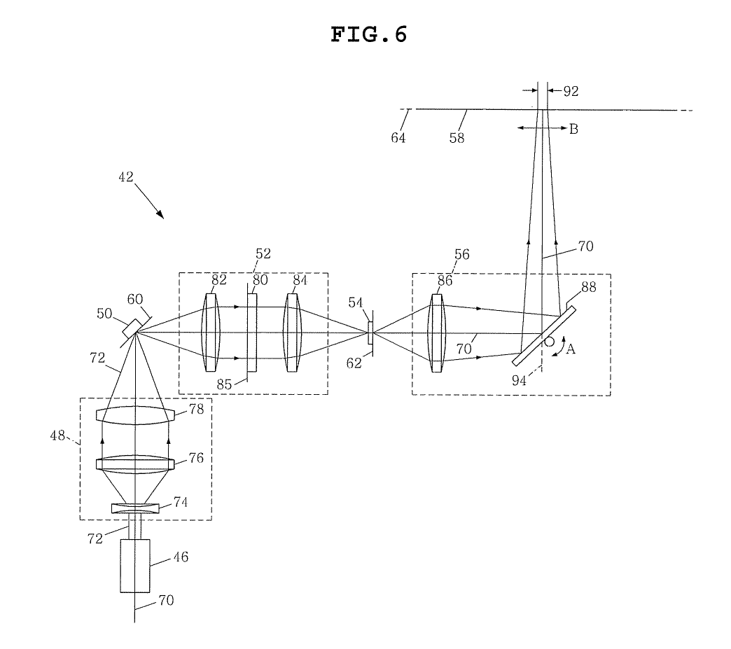

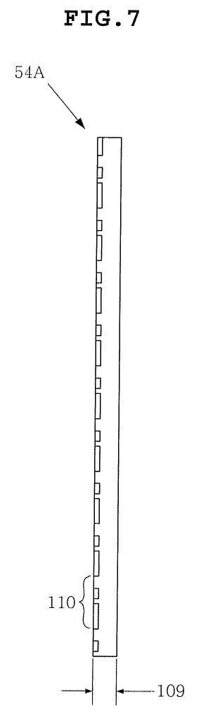

At this time, the light source unit 110 generates each beam of light using a plurality of sources that emit light in a wavelength band corresponding to the beam of light. That is, the light source unit 110 uses a red light source array 111a in order to generate red light. The red light source array 111a includes an array of a plurality of red light sources, which emit light in a red light wavelength band (refer to FIG. 3). The red light source array 111a emits red light including reference red light and a plurality of beams of red light having wavelengths adjacent thereto. Furthermore, the light source unit 110 uses a green light source array 111b in order to generate green light. The green light source array 111b includes an array of a plurality of green light sources, which emit light in a green light wavelength band. The green light source array 111b emits green light, which including reference green light and a plurality of beams of green light having wavelengths adjacent thereto. Moreover, the light source unit 110 uses a blue light source array 111b in order to generate blue light. The blue light source array 111c includes an array of a plurality of blue light sources, which emit light in a blue light wavelength band. The blue light source array 111c emits blue light including reference blue light and a plurality of beams of blue light having wavelengths adjacent thereto.

Laser diodes or light emitting diodes may be used as the red light sources, the green light sources and the blue light sources, which are used in the red light source array 111a, the green light source array 111b, and the blue light source array 111c. Meanwhile, if the light source unit 110 emits red light, green light and blue light in a time division manner in the case where a single diffractive light modulator 118 is employed, as in the present embodiment of the present invention, it is not necessary to provide a color wheel (a device capable of temporally dividing a multi-beam according to color; not shown) upstream or downstream of the diffractive light modulator 118. Of course, if the light source unit 110 simultaneously emits a plurality of beams of light, that is, the light source unit 110 emits a plurality of beams of light without time division, it is possible to provide a color wheel upstream or downstream of the diffractive light modulator 118, and thus cause a plurality of beams of light to enter the diffractive light modulator 118 at different times, rather than simultaneously.

The light condensing unit 112 includes one reflective mirror 113a and two dichroic mirrors 113b and 113c in one embodiment, and causes light, emitted from the plurality of light source arrays 111a, 111b and 111c, to have the same light path. That is, the reflective mirror 113a causes red light to propagate along a desired light path by changing the light emitted from the red light source array 111a, the dichroic mirror 113b located downstream of the reflective mirror 113a causes the red light and green light to propagate along the same light path by passing the red light therethrough and reflecting the green light from the green light source array 111b, and the dichroic mirror 113c located downstream of the dichroic mirror 113b causes the red light, the green light and blue light to propagate along the same light path by passing the red light and the green light therethrough and reflecting the blue light from the blue light source array 111c.

Meanwhile, the collimating lens unit 115 of the illumination unit 114 is located between the light source unit 110 and the light condensing unit 112. Here, the collimating lens unit 115 includes a plurality of collimating lenses 115a, 115b and 115c. The collimating lenses 115a, 115b and 115c are located so as to correspond to respective light source arrays 111a, 111b and 111c of the light source unit 110, and convert beams of divergent light, emitted from respective light source arrays 111a, 111b and 111c, into parallel light.

The cylinder lens 116 of the illumination unit 114 is located downstream of the light condensing unit 112, and functions to convert parallel light, emitted from the light condensing unit 112, into linear light and cause the linear light to enter the diffractive light modulator 118.

Although, in the embodiment of the present invention, the collimating lens unit 115 of the illumination unit 114 is located between the light source unit 110 and the light condensing unit 112 and the cylinder lens 116 is located downstream of the light condensing unit 112, the collimating lens 115 of the illumination unit 114 may be located downstream of the light condensing unit 112 in another embodiment of the present invention. If so, desired parallel light can be generated using only a single collimating lens, unlike the parallel light, which is generated using the collimating lens unit 115, which includes the three collimating lenses 115a, 115b and 115c, as shown in FIG. 1, so that a reduction in cost can be realized.

Next, when the linear parallel light is incident from the illumination unit 114, the diffractive light modulator 118 generates diffracted light having a plurality of diffraction orders by modulating the parallel light, and emits the diffracted light. Here, the diffracted light having a plurality of diffraction orders, emitted from the diffractive light modulator 118, is linear light with respect to diffraction order.

The intensity of diffracted light having one or more desired diffraction orders, which belongs to the diffracted light having a plurality of diffraction orders emitted from the diffractive light modulator 118, is projected onto the screen 126, and forms images, may be made to vary at respective points of the light path thereof, so that desired images can be formed by projecting diffracted light having one or more relevant diffraction orders onto the screen 126. Furthermore, the diffracted light having a plurality of diffraction orders, emitted from the diffractive light modulator 118, propagates at a plurality of diffraction angles.

The projection unit 120 includes a projection lens 121, a filter 122, and a scanner 123, and functions to select diffracted light having one or more desired diffraction orders from the diffracted light having a plurality of diffraction orders emitted from the diffractive light modulator 118, pass the selected diffracted light therethrough, and form two-dimensional images by magnifying the passed diffracted light and scanning the magnified diffracted light across the screen 126.

The projection lens 121 of the projection unit 120 magnifies the diffracted light having a plurality of diffraction orders emitted from the diffractive light modulator 118.

A slot or dichroic filter is used as the filter 122. The filter 122 passes diffracted light having one or more desired diffraction orders, which belongs to the diffracted light having a plurality of diffraction orders emitted from the projection lens 121, therethrough, and blocks diffracted light having undesired diffraction orders. It is not necessary for the filter 122 to have a separate Fourier lens.

That is, as described above, the diffracted light having a plurality of diffraction orders, emitted from the diffractive light modulator 118, propagates at different diffraction angles. If the filter 122 is disposed at a sufficient distance from the diffractive light modulator 118, the diffracted light having a plurality of diffraction orders enters the filter 122 in the state in which the minimum distance between beams of diffracted light having respective diffraction orders is sufficient for the slot or dichroic filter to separate the diffracted light having a plurality of diffraction orders, so that a separate Fourier lens is not required.

Meanwhile, the filter 122 may not be disposed downstream of the projection lens 121, unlike that in the embodiment of FIG. 1, but may be disposed downstream of the diffractive light modulator 118, like that in another embodiment. In this case, the filter 122 includes a Fourier lens. The Fourier lens separates the diffracted light having a plurality of diffraction orders so that the minimum distance between beams of diffracted light having respective diffraction orders can be sufficiently ensured, and the filter 122 passes diffracted light having one or more desired diffraction orders.

The scanner 123 of the projection unit 120 forms two-dimensional images by scanning the linear diffracted light having a plurality of diffraction orders, magnified by the projection lens 121, onto the screen 126.

A Galvanometer mirror or polygon mirror may be used as the scanner 122.

The Galvano scanner has a square plate shape, and is provided with a mirror on one surface of a square plate. The Galvano scanner laterally rotates within a predetermined angular range around an axis. The polygon mirror scanner has a polygonal column shape, and is provided with mirrors on the side surfaces of a polygonal column. The polygonal mirror scanner projects images onto the screen 128 by varying the reflection angle of incident light using the mirrors attached to the sides thereof while rotating in one direction around an axis.

FIG. 2 is a diagram showing incident angles, at which beams of light, emitted from the plurality of light sources of FIG. 1, enter the diffractive light modulator. FIG. 3 is a diagram showing the relationship between the distances between the light sources of the light source array of FIG. 1 and incident angles.

FIGS. 2 and 3 show beams of light that are emitted from a single light array that includes four light sources.

Referring to these drawings, the incident angles at which light in the wavelength band of the same color, emitted from the illumination unit 114, enters the diffractive light modulator 118 are θ₁, θ₂, θ₃ and θ₄. In this case, if the distances between the four light sources of the red light source array 111a are d1, d2, d3 and d4, the relationship Between θ₁, θ₂, θ₃ and θ₄ is θ₂=θ₁+d1/f4, θ₃=θ₁+d2/f4, and θ₄=θ₁+d3/f4. In this case, f4 is the focal distance from the illumination unit 114 to the diffractive light modulator 118. In this drawing, the wavelength of light emitted from the first red light source (source 1) of the red light source array 111a is indicated by λ₁, the wavelength of light emitted from the second red light source (source 2) is indicated by λ₂, the wavelength of light emitted from the third red light source (source 3) is indicated by λ₃, and the wavelength of light emitted from the fourth red light source (source 4) is indicated by λ₄.

With regard to the wavelength tolerance of emitted light in the light source arrays 111a, 111b and 111c, if the reference wavelength is λ₀, the difference Δλ in wavelength between beams of light emitted from adjacent light sources is Δλ=λᵢ−λᵢ₊₁≧λ₀/4σ. Here, σ is the root-mean-square (RMS) of the height of the screen surface roughness of the screen 126.

Meanwhile, if the difference in height between the upper reflective parts and the lower reflective part, which is required in order to form diffracted light in the diffractive light modulator 118, is h, the relationship between the incident angle θᵢ and incident wavelength λᵢ, which is required to form 0th-order diffracted light, must be h cos(θᵢ)=λᵢ(0.5n+0.25), and the relationship between the incident angle θᵢ and the incident wavelength λᵢ, which is required to form ±1th-order diffracted light, must be h cos(θᵢ)=λᵢ0.5n.

In order to understand the above relationships, an open hole-based diffractive light modulator, which is applied to the present invention, will be described in brief below.

FIG. 4 is a perspective view showing an open hole-based diffractive light modulator, which is applied to the present invention.

Referring to the drawing, the open hole-based diffractive optical modulator, which is applied to the present invention, includes a substrate 201.

The open hole-based diffractive optical modulator further includes an insulating layer 202 that is formed on the substrate 201.

The open hole-based diffractive optical modulator further includes a lower reflective part 203 that is formed on part of the insulating layer 202 and is configured to reflect incident light that passes through the holes 206aa to 206nb of upper reflective parts 206a to 206n and the spaces between the upper reflective parts 206a to 206n.

The open hole-based diffractive optical modulator further includes a pair of side support members 204 and 204′ that allow the lower reflective part 203 to be interposed therebetween, and are formed on the surface of the substrate 201 to be spaced apart from each other.

The open hole-based diffractive optical modulator further includes a plurality of laminate support plates 205a to 205n that have side portions supported by the pair of side support members 204 and 204′, are spaced apart from the substrate 201, have central portions movable upward and downward, have holes (not shown) corresponding to the holes 206aa to 206nb formed in the upper reflective parts 206a to 206n at the central portions thereof, and constitute an array.

The open hole-based diffractive optical modulator further includes the upper reflective parts 206a to 206n that are respectively formed at the central portions of the laminate support plates 205a to 205n, have the holes 206aa to 206nb at the centers thereof, so that they reflect some incident light and allow the remaining incident light to pass through the holes 206aa to 206nb, and constitute an array.

The open hole-based diffractive optical modulator further includes a plurality of pairs of piezoelectric layers 210a to 210n and 210a′ to 210n′ that are formed over the laminate support plates 206a to 206n, are spaced apart from each other, are placed over the side support members 204 and 204′, and are configured to move the laminate support plates 206a to 206n upward and downward.

In the piezoelectric layers 210a to 210n and 210a′ to 210n′, when voltage is applied to the lower electrode layers 210aa to 210na and 210aa′ to 210na′, the piezoelectric material layers 210ab to 210nb and 210ab to 210nb′ and the upper electrode layers 210ac to 210nc and 210ac′ to 210nc, the central portions of the laminate support plates 205a to 205n move upward and downward due to the contraction and expansion of the piezoelectric material layers 210ab to 210nb and 210ab′ to 210nb′. Accordingly, the upper reflective parts 206a to 206n move upward and downward.

Meanwhile, when light is incident on the upper reflective parts 206a to 206n of the open hole-based diffractive optical modulator, the upper reflective parts 206a to 206n reflect part of the incident light and allow the remaining part of the incident light to pass through the holes 206aa to 206nb, and the lower reflective part 203 reflects light that has passed through the holes 206aa to 206nb of the upper reflective parts 206a to 206n.

As a result, the light reflected from the upper reflective parts 206a to 206n and the light reflected from the lower reflective part 203 forms diffracted light having several diffraction orders. The intensity of the diffracted light is highest when the difference in height between the upper reflective parts 206a to 206n and the lower reflective part 203 is an odd multiple of λ/4 where λ is the wavelength of the incident light, and is lowest when the difference in height between the upper reflective parts 206a to 206n and the lower reflective part 203 is an even multiple of λ/4.

The difference in height is determined according to the following two factors: 1) the wavelength of incident light, and 2) the incident angle of incident light. Accordingly, in the present invention, the factors are met by increasing the incident angle in proportion to the increase in the wavelength of incident light. That is, as described above, if the difference in height between the upper reflective parts and the lower reflective part, which is required to form diffracted light in the diffractive light modulator 118, is h, the relationship between the incident angle θᵢ and the incident wavelength λᵢ, which is required to form 0th-order diffracted light, must be h cos(θᵢ)=λᵢ(0.5n+0.25), and the relationship between the incident angle θᵢ and the incident wavelength λᵢ, which is required to form ±1th-order diffracted light, must be h cos(θᵢ)=λᵢ0.5n.

According to the display system of the present invention, the speckles of light are reduced using a plurality of light sources having simple constructions and different wavelengths, so that it is easy to fabricate optical elements or a display system and the time of the fabrication thereof can be considerably reduced, compared to those of the prior art.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A display device using a diffractive light modulator, comprising:
a light source unit for generating light, including a plurality of wavelengths corresponding to each relevant color, using a plurality of light sources that emit light in a wavelength band corresponding to the color, and emitting the generated light;
an illumination unit for focusing the emitted light;
a diffractive light modulator for generating diffracted light by modulating the focused light; and
a projection unit for magnifying the modulated light and projecting the magnified modulated light onto a screen.

2. The display device as set forth in claim 1, wherein the light source unit comprises a light source array that includes a plurality of light sources for emitting light in the wavelength band corresponding to the color, and generates and emits the light that includes the plurality of wavelengths corresponding to the color.

3. The display device as set forth in claim 1, wherein, if reference wavelength is λ₀ and a root-mean-square of height of screen surface roughness of the screen is σ, a difference Δλ in wavelength between beams of light emitted from adjacent light sources satisfies Δλ=λᵢ−λᵢ₊₁≧λ0/4σ.

4. The display device as set forth in claim 3, wherein the diffractive light modulator comprises first reflective parts and a second reflective part, and, if a difference in height between the first reflective parts and the second reflective part, which is required to form the diffracted light in the diffractive light modulator 118, is h, a relationship between an incident angle θi and an incident wavelength λi, which is required to form 0th-order diffracted light, must be h cos(θi)=λi(0.5n+0.25), and a relationship between an incident angle θi and an incident wavelength λi, which is required to form ±1th-order diffracted light, must be h cos(θᵢ)=λᵢ0.5n.

5. The display device as set forth in claim 1, wherein the projection unit comprises:
a projection lens for magnifying the diffracted light having a plurality of diffraction orders emitted from the diffractive light modulator; and
a scanner for scanning the diffracted light, incident from the projection lens, across the screen.

6. The display device as set forth in claim 5, wherein the projection unit comprises a filter that is located between the scanner and the screen and passes diffracted light having one or more desired diffraction orders, selected from the diffracted light having a plurality of diffraction orders, emitted from the scanner, therethrough.

7. The display device as set forth in claim 5, wherein the projection unit comprises a filter that is located downstream of the diffractive light modulator and passes diffracted light having one or more desired diffraction orders, selected from the diffracted light having a plurality of diffraction orders, emitted from the diffractive light modulator, therethrough.
